(19) United States
(12) Patent Application Publication
(10) Pub. No.: US 2012/0105215 A1
(43) Pub. Date: May 3, 2012

(54) PORTABLE READER

(75) Inventors: Gregory S. Gronau, Las Vegas, NV (US); Emmanuel Gelinotte, Savigny Les Beaune (FR); Francisco Javier Moreno, Yuma, AZ (US); Justin Woodard, Las Vegas, NV (US)

(73) Assignee: Gaming Partners International USA, Inc., Las Vegas, NV (US)

(21) Appl. No.: 13/282,692

(22) Filed: Oct. 27, 2011

Related U.S. Application Data
(60) Provisional application No. 61/407,381, filed on Oct. 27, 2010.

(51) Int. Cl. G06K 7/01; G06F 17/00

(52) U.S. Cl. 340/10.51; 235/375

(57) ABSTRACT

The invention generally pertains to a portable gaming currency reader for reading RFID-enabled gaming currency. By way of example, one portable gaming currency reader has a portable reader housing having a currency reading surface, a shielded antenna located adjacent to the currency reading surface for reading and communicating with the memory of each RFID tag embedded within RFID-enabled gaming currency located on the currency reading surface, and an RFID reader coupled to the shielded antenna for communicating with the shielded antenna to identify, read from and write to each RFID tag associated with RFID-enabled gaming currency located on the currency reading surface. The reader is also provided with a display configured for indicating information about the RFID-enabled gaming currency located on the currency reading surface, such as number and value.

### FIELD OF THE INVENTION

The present invention is directed to a portable reader that utilizes RFID technology to authenticate gaming currency. More specifically, the present invention is directed to a high frequency chip reader that communicates with the memory of RFID-enabled gaming currency placed on a reading surface and outputs the information read from memory to an LCD or LED display.

### BACKGROUND INFORMATION

RFID microchips installed in gaming chips, plaques or jetons (i.e., gaming currency) provide a secure and reliable way to track and record the chip's movement throughout a casino. Because each chip has a unique tag that is encoded with the chip's monetary value, it can be instantly identified and validated when it comes in proximity with an RFID reader. This makes RFID microchips an ideal way to improve the accuracy of currency counting and cage inventory procedures while also providing a level of currency security that is difficult to breach.

Because gaming currency represents a significant point of vulnerability from counterfeiters and other theft opportunities, RFID-enabled gaming currency (i.e., gaming currency having RFID tags or microchips embedded within the interior of the currency) provides one of the highest levels of security available. Additionally, by implementing RFID-enabled casino currency along with a chip tracking system, a wealth of information is available about where the currency is at all times, their movement and more. Accordingly, casino operators are continuously seeking ways of enabling its staff to quickly and accurately track, read, authenticate and count casino currency from any location within the casino at any time.

### BRIEF DESCRIPTION OF THE FIGURES

FIG. 1 is a perspective view of an embodiment of portable chip reader in accordance with one aspect of the present invention;

FIG. 2 is a perspective view of an embodiment of portable chip reader of FIG. 1 with the spring loaded chip drawer in the open position;

FIG. 3 is an exploded view of the various components making up the portable chip reader of FIG. 1;

FIG. 4 is a front perspective view of another embodiment of a portable chip reader;

FIG. 5 is a side view of the portable chip reader of FIG. 4; and

FIG. 6 is a front perspective view of the portable chip reader of FIG. 4, showing the x-axis, y-axis and z-axis of the currency reading surface as well as the orientation of the center axis of casino currency stacked directly on the currency reading surface of the reader and stored in currency trays on the currency reading surface.

### BRIEF DESCRIPTION

The portable gaming currency reader of the present invention provides a method and apparatus for casinos to authenticate and validate RFID-enabled casino currency. More specifically, the portable gaming currency reader illustrated and described herein enables casino staff to quickly and accurately read, authenticate, and count casino currency from any location at any time. The portable reader extends the RFID protection from the cage or chip bank to the table, pit podium or even back-of-the-house counting areas. In one embodiment, the high speed reading capabilities of the RFID reader associated with the portable gaming currency reader make it possible to read several hundred items of currency per second while simultaneously identifying whether the gaming currency is authentic and valid—a key advantage that makes it possible for casino staff to easily identify and remove foreign, non-casino currency. Encased in a portable case that may be customized with a casino's unique logo, the portable gaming currency reader is able to authenticate RFID-enabled gaming currency that is either stacked directly on a currency reading surface or placed on the reading surface in currency trays. All validation information appears on a display that is configured to show the number of pieces being authenticated as well as the total value amount.

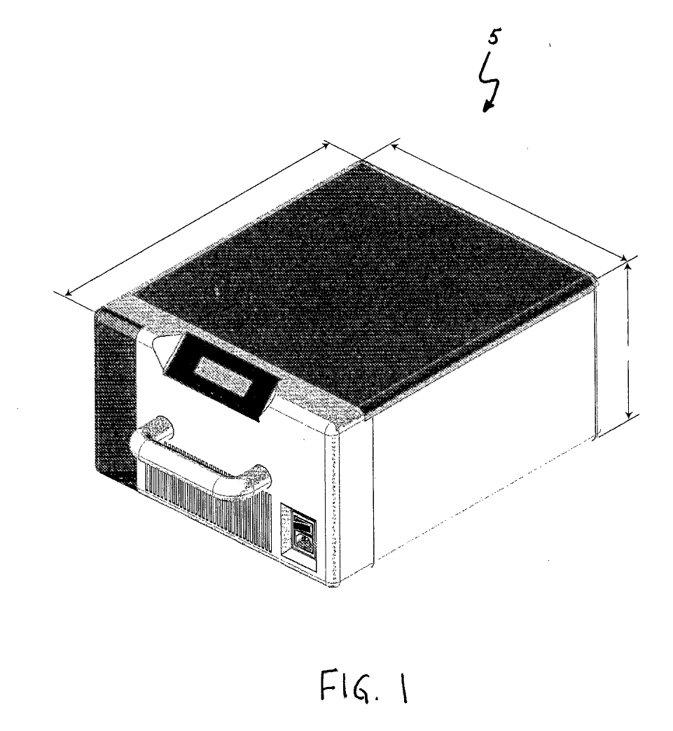

In accordance with one aspect of the present invention, FIG. 1 illustrates one embodiment of a portable chip reader 5 in accordance with one aspect of the present invention. Portable chip reader 5 is built to be transportable and deployable in several different ways within a gaming environment. In operation, portable reader offers standalone authentication of RFID chips including ownership, value, and the like. Portable reader 5 is configured to authenticate RFID chips starting with a single chip up to several hundred chips in trays or stacks. Portable gaming currency reader typically operates high frequencies, but may also operate using ultrahigh frequencies (UHF) or microwave (MW), as those terms are known in the gaming industry.

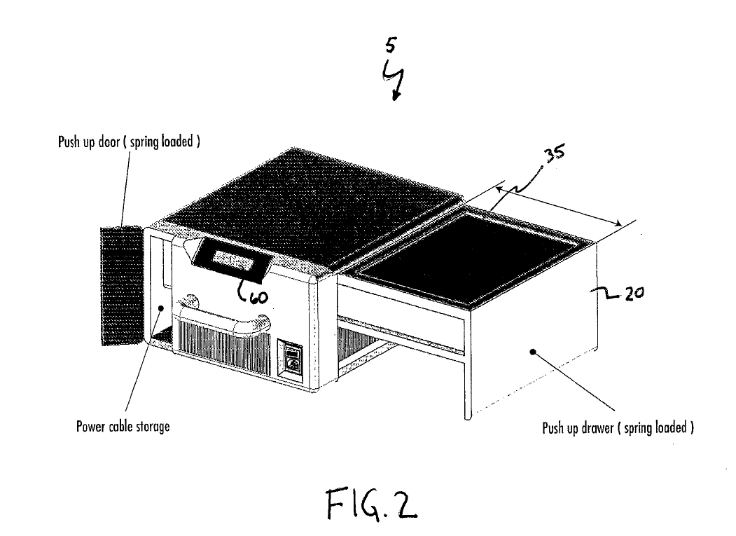

FIG. 2 illustrates the portable reader 5 with the spring loaded push up drawer 20 in the open position. In operation, the shielded antenna 35 would be lifted and the RFID chips would be placed within the drawer 20 in trays or stacks. The drawer is then closed and the power to the unit is activated. The portable reader 5 performs various calculations and thereafter outputs the total amount and the total number of chips on the LCD or LED display 60. Portable reader 5 allows a user to authenticate a batch of chips immediately at the unit's location.

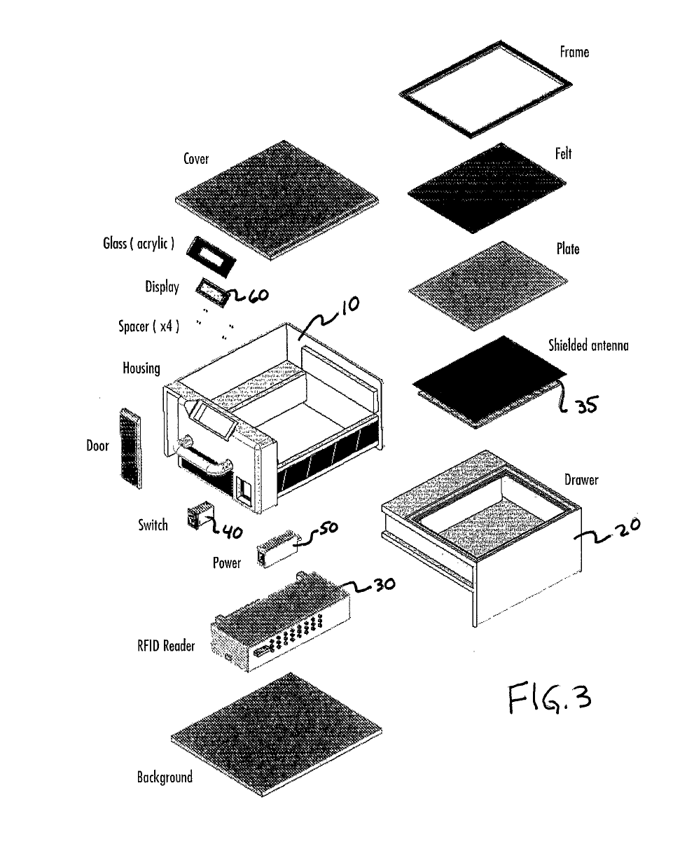

FIG. 3 shows the various components of the portable reader 5. In the illustrated embodiment, portable reader 5 is generally comprised of a reader housing 10, a chip drawer 20, handle 25, an RFID reader 30, a shielded antenna 35, an on/off switch 40, power adapter 50, and LCD or LED display 60. In the illustrated embodiment, RFID reader 30 is a Magellan Multiple Antenna Reader System (MARS-24) RFID reader designed to verify, inventory, monitor and control RFID chips having the ability to identify, read and write reliably to many hundreds of tags a second, however, as one of ordinary skill in the art will recognize, any suitable RFID reader may be used without departing from the scope and spirit of the present invention.

Handle 25 is illustrated as protruding from the front of housing 10. In an alternate embodiment, handle 25 is connected to the front face of drawer 20 to facilitate opening and closing and a recessed hand grab mechanism (not shown) would be used on the face of the housing 10 in the location handle 25 is shown. Recessed hand grab mechanism would have a recess for accommodating the fingers of a user and would be strong enough to support the weight of portable reader 5 when carrying from location to location.

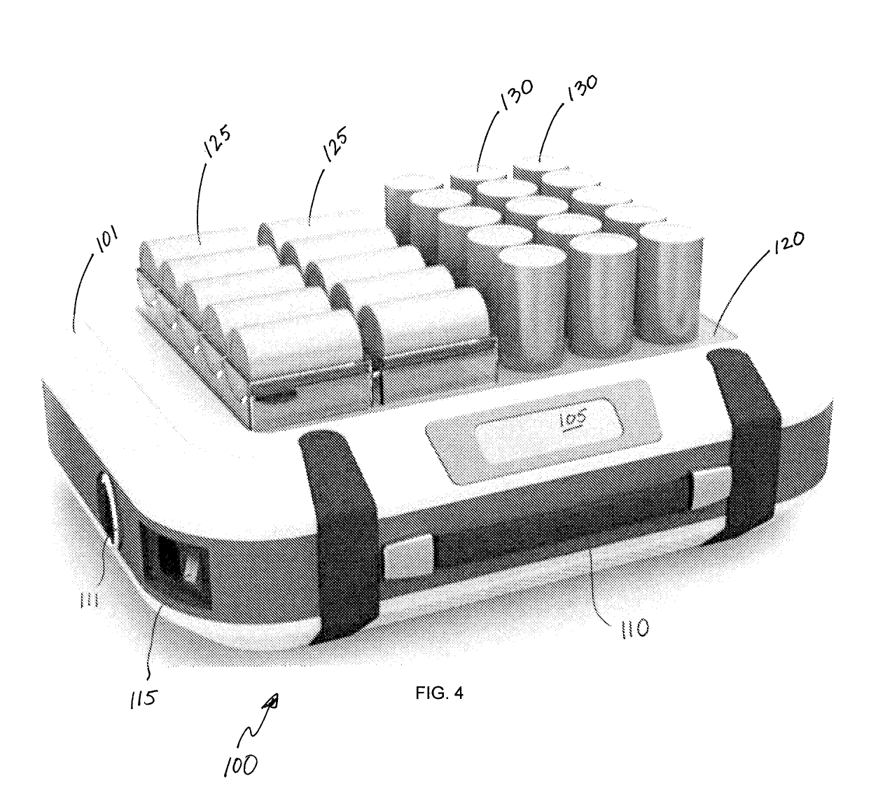

FIG. 4 illustrates another embodiment of portable gaming currency reader 100 for reading RFID-enabled gaming currency 125, 130. Portable gaming currency reader 100 comprises a portable reader housing 101 having a currency reading surface 120. A handle 110 is coupled to the portable reader housing 101 so as to make the unit transferrable from location to location by casino staff. In the illustrated embodiment, the portable reader housing 101 is also provided with two loops 111 for attaching a shoulder harness (not shown) so as to allow the reader 100 to be carried in a similar manner to an over the shoulder bag.

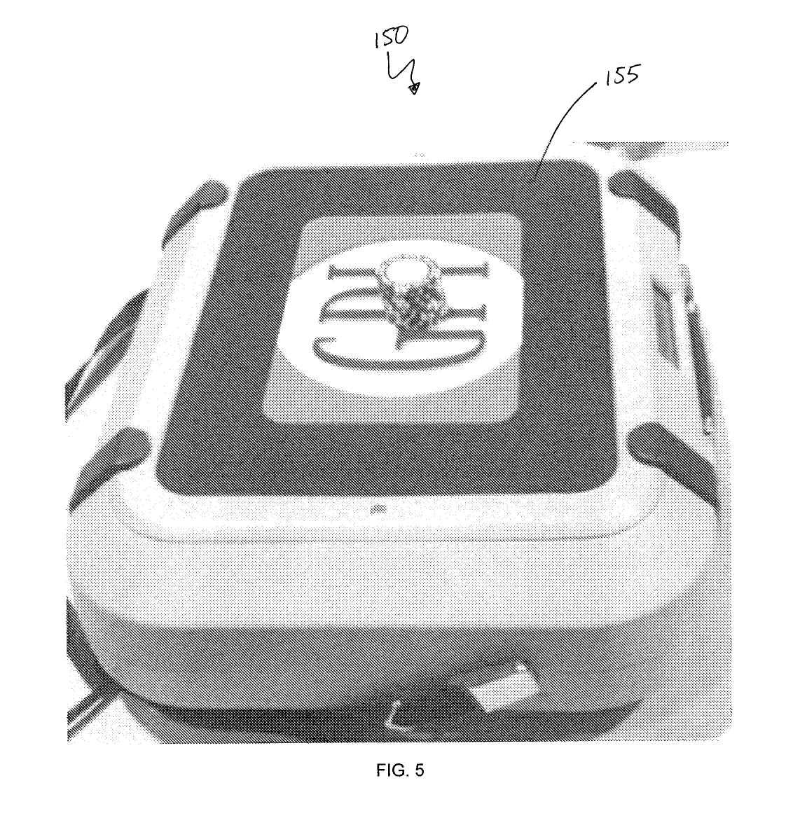

The currency reading surface 120 is configured for placing RFID-enabled gaming currency on its surface for performing an authentication and verification procedure in accordance with the operation of the portable gaming currency reader 100. Currency reading surface 120 is located adjacent to a shielded antenna (not shown). The shielded antenna is configured to read and communicate with the memory of each RFID tag embedded within RFID-enabled gaming 125, 130 currency located on the currency reading surface 120. FIG. 5 illustrates an alternate embodiment of a portable currency reader 150 having a currency reading surface 155 customized with a particular logo.

The shielded antenna is coupled to an RFID reader (not shown). The RFID reader is configured to communicate with the shielded antenna to identify, read from and write to each RFID tag embedded within RFID-enabled gaming currency 125, 130 located on the currency reading surface 120. In the illustrated embodiment, RFID reader is a Magellan Multiple Antenna Reader System (MARS-24) RFID reader designed to verify, inventory, monitor and control RFID chips having the ability to identify, read and write reliably to many hundreds of tags a second, however, as one of ordinary skill in the art will recognize, any suitable RFID reader may be used without departing from the scope and spirit of the present invention. Portable gaming currency reader 100 typically operates high frequencies, but may also operate using ultrahigh frequencies (UHF) or microwave (MW), as those terms are known in the gaming industry.

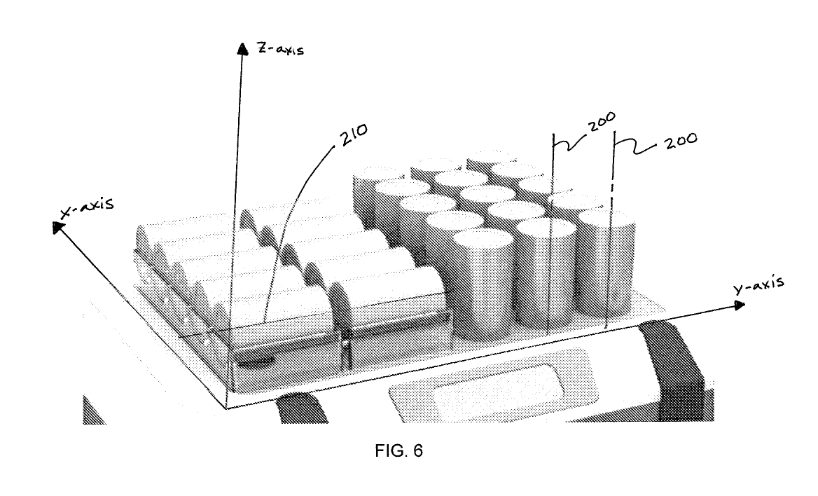

In one embodiment, shielded antenna is a dual-axis or two-dimensional antenna for identifying, reading from and writing to each RFID tag associated with RFID-enabled gaming currency orientated in two directions on the currency reading surface 120. In another embodiment, shielded antenna is a tri-axis or three-dimensional antenna for identifying, reading from and writing to each RFID tag associated with RFID-enabled gaming currency orientated in three directions on the currency reading surface 120. The two and three directional reading capability of the shielded antenna will be further illustrated and described with respect to FIG. 6.

The portable reader housing 101 is also provided with a display 105. The display 105 is configured for indicating information about the RFID-enabled gaming currency 125, 130 located on the currency reading surface 120. For example, the display 105 may indicate both the total number of pieces and the total value amount of the casino currency 125, 130 placed on the currency reading surface 120. In another embodiment, the display 105 may identify whether the casino currency 125, 130 placed on the currency reading surface is authentic, valid casino currency and display the authentication results. In yet another embodiment, the display 105 may display an error message for non RFID-enabled gaming currency located on the currency reading surface or for RFID-enabled gaming currency located on the currency reading surface that is not associated with the particular casino. Portable gaming currency reader 100 may be provided with wireless networking capabilities such that the information shown on display 105 may also be transmitted remotely to a second location for logging, review, etc.

FIG. 6 illustrates the two and three dimensional aspects of the shielded antenna (not shown) of the portable gaming currency reader 100. Both the centerline 200 of stacked casino currency and the centerline 210 of casino currency in trays are shown. As illustrated, the shielded antenna of said currency reading surface has an x-axis along the width of the currency reading surface, a y-axis along the length of the currency reading surface, and a z-axis perpendicular to the currency reading surface. In one embodiment, when the shielded antenna is a dual-axis or two-dimensional antenna for identifying, reading from and writing to each RFID tag associated with RFID-enabled gaming currency orientated in two directions on the currency reading surface, the centerline 210 of the casino currency in trays is parallel to the y-axis and the centerline 200 of the casino currency stacked directly on the currency reading surface 120 is parallel to the z-axis as shown. Accordingly, the RFID-enabled casino currency may be read by the RFID reader in two directions on the currency reading surface, i.e. along the y-axis and along the z-axis.

In an alternate embodiment, when the shielded antenna is a tri-axis or three-dimensional antenna for identifying, reading from and writing to each RFID tag associated with RFID-enabled gaming currency orientated in two directions on the currency reading surface, the centerline 210 of the casino currency in trays may be parallel to the y-axis as shown or parallel to the x-axis (not shown) and the centerline 200 of the casino currency stacked directly on the currency reading surface 120 is parallel to the z-axis as shown. Accordingly, the RFID-enabled casino currency may be read by the RFID reader in three directions on the currency reading surface, i.e. along the x-axis, the y-axis and the z-axis.

In operation, the casino staff member would transport the portable gaming currency reader to a particular location having RFID-enabled chips to be read, authenticated, counted and logged. The portable gaming currency reader has a currency reading surface, an RFID reader coupled to a shielded antenna located adjacent to the currency reading surface, a display for indicating both the number and value of the gaming currency located on the currency reading surface, and a power supply for providing power to the RFID reader and the display. The staff person activates the power supply to the portable gaming currency reader. Next, the individual places RFID-enabled gaming currency having at least one RFID tag associated therewith on the currency reading surface.

In response, the RFID reader and the shielded antenna communicate to identify, read from and write to the at least one RFID tag associated with RFID-enabled gaming currency located on the currency reading surface. Finally, the display presents information about the RFID-enabled gaming currency located on the currency reading surface, such as number and value. In an alternate embodiment, the RFID reader identifies whether the casino currency placed on the currency reading surface is authentic, valid casino currency and the display shows the authentication results on the display.

In one embodiment of the portable reader, the currency reading surface has an x-axis along the width of the currency reading surface, a y-axis along the length of the currency reading surface, and a z-axis perpendicular to the currency reading surface. In operation, the RFID-enabled currency is placed on the currency reading surface in a stack such that the centerline of the gaming currency is parallel to the z-axis. The RFID reader is able to accurately read the information from the RFID tag embedded within the RFID-enabled gaming currency. In another operation, the RFID-enabled currency is placed on the currency reading surface such that the centerline of the gaming currency is parallel to the y-axis. The RFID reader is configured to accurately read the information from the RFID tag embedded within the RFID-enabled gaming currency. In yet another embodiment, for the operation of a tri-axis antenna, the RFID-enabled currency is placed on the currency reading surface such that the centerline of the gaming currency is parallel to the x-axis. The RFID reader is configured to accurately read the information from the RFID tag embedded within the RFID-enabled gaming currency.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment. Furthermore, the particular features, structures or characteristics may be combined as desired in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects.

While the invention has been particularly shown and described with reference to various embodiments thereof, it will be understood by those skilled in the art that various other changes in the form and details may be made without departing from the spirit and scope of the invention.

We claim:

1. A portable gaming currency reader for reading RFID-enabled gaming currency comprising:
a portable reader housing having a currency reading surface;
a shielded antenna located adjacent to the currency reading surface, the shielded antenna configured to read and communicate with the memory of each RFID tag embedded within RFID-enabled gaming currency located on the currency reading surface;
an RFID reader coupled to the shielded antenna, the RFID reader configured to communicate with the shielded antenna to identify, read from and write to each RFID tag embedded within RFID-enabled gaming currency located on the currency reading surface;
a display configured for indicating information about the RFID-enabled gaming currency located on the currency reading surface; and
a power source for supplying power to the RFID reader and the display.

2. The portable gaming currency reader of claim 1, wherein said shielded antenna is a dual-axis antenna for identifying, reading from and writing to each RFID tag associated with RFID-enabled gaming currency orientated in two directions on the currency reading surface.

3. The portable gaming currency reader of claim 1, wherein said shielded antenna is a tri-axis antenna for identifying, reading from and writing to each RFID tag associated with RFID-enabled gaming currency orientated in three directions on the currency reading surface.

4. The portable gaming currency reader of claim 1, wherein said shielded antenna of said currency reading surface has an x-axis along the width of the currency reading surface, a y-axis along the length of the currency reading surface, and a z-axis perpendicular to the currency reading surface.

5. The portable gaming currency reader of claim 4, wherein said shielded antenna is configured to communicate with RFID-enabled gaming currency having its center axis placed parallel to the z-axis.

6. The portable gaming currency reader of claim 5, wherein said shielded antenna is configured to communicate with RFID-enabled gaming currency having its center axis placed parallel to the y-axis.

7. The portable gaming currency reader of claim 6, wherein said shielded antenna is configured to communicate with RFID-enabled gaming currency having its center axis placed parallel to the x-axis.

8. The portable gaming currency reader of claim 1, wherein said display indicates both the total number of pieces and the total value amount of the casino currency placed on the currency reading surface.

9. A method for reading RFID-enabled gaming currency with a portable gaming currency reader, the method comprising:
providing a portable gaming currency reader having a currency reading surface, an RFID reader coupled to a shielded antenna located adjacent to the currency reading surface, a display for indicating both the number and value of the gaming currency located on the currency reading surface, and a power supply for providing power to the RFID reader and the display;
activating the power supply to the portable gaming currency reader;
placing RFID-enabled gaming currency having at least one RFID tag associated therewith on the currency reading surface;
communicating between the RFID reader and the shielded antenna to identify, read from and write to the at least one RFID tag associated with RFID-enabled gaming currency located on the currency reading surface; and
displaying information about the RFID-enabled gaming currency located on the currency reading surface on the display.

10. The method of claim 9, said method further comprising identifying whether the casino currency placed on the currency reading surface is authentic, valid casino currency and displaying the authentication results on the display.

11. The method of claim 10, said method further comprising displaying both the number and value of RFID-enabled gaming currency located on the currency reading surface.

12. The method of claim 11, said method further comprising displaying an error message for non RFID-enabled gaming currency located on the currency reading surface.

13. The method of claim 12, said method further comprising displaying an error message for RFID-enabled gaming currency located on the currency reading surface that is not associated with the casino.

14. The method of claim 9, wherein said currency reading surface has an x-axis along the width of the currency reading surface, a y-axis along the length of the currency reading surface, and a z-axis perpendicular to the currency reading surface, said method further comprising placing the RFID-enabled currency on the currency reading surface such that the centerline of the gaming currency is parallel to the z-axis.

15. The method of claim 14, said method further comprising placing the RFID-enabled currency on the currency reading surface such that the centerline of the gaming currency is parallel to the y-axis.

16. The method of claim 15, said method further comprising placing the RFID-enabled currency on the currency reading surface such that the centerline of the gaming currency is parallel to the x-axis.

17. A method of providing portable gaming currency reader for reading RFID-enabled gaming currency comprising:
providing a portable reader housing having a currency reading surface;
providing a shielded antenna located adjacent to the currency reading surface, the shielded antenna configured to read and communicate with the memory of each RFID tag embedded within RFID-enabled gaming currency located on the currency reading surface;
providing an RFID reader coupled to the shielded antenna, the RFID reader configured to communicate with the shielded antenna to identify, read from and write to each RFID tag embedded within RFID-enabled gaming currency located on the currency reading surface;
providing a display configured for indicating information about the RFID-enabled gaming currency located on the currency reading surface; and
providing a power source for supplying power to the RFID reader and the display.
